(19) United States
(12) Patent Application Publication
(10) Pub. No.: US 2026/0226955 A1
(43) Pub. Date: Aug. 6, 2026

(54) ELASTOMERIC BUSHING WITH INTERNAL SNUBBER

(71) Applicant: The Pullman Company LLC, Northville, MI (US)

(72) Inventor: Michael BIXLER, Milan, OH (US)

(21) Appl. No.: 19/045,722

(22) Filed: Feb. 5, 2025

(51) Int. Cl. F16F 1/38

(52) U.S. Cl. CPC F16F 1/3835; F16F 1/3828; F16F 2224/025; F16F 2230/0041; F16F 2234/02

(57) ABSTRACT

An elastomeric bushing comprises a first bushing subassembly and a second bushing subassembly each in engagement with an outer surface of an inner component. The first bushing subassembly includes a first inner sleeve, a first outer sleeve and a first elastomeric bumper radially positioned between the first inner and outer sleeves. The first elastomeric bumper includes a first axial flange positioned between a first flange of a first inner sleeve and a first end wall of the first outer sleeve. The second bushing assembly is substantially the same as the first bushing assembly. The first and second inner sleeves of each bushing subassembly are in engagement with the outer surface of the inner component.

The present disclosure relates to an elastomeric bushing for interconnecting a component with a vehicle. More particularly, the present disclosure relates to an elastomeric bushing including an increased axial spring rate.

### BACKGROUND

The statements in this section merely provide background information related to the present disclosure and may not constitute prior art.

Most all vehicles include a suspension system to interconnect the chassis of the vehicle (the unsprung portion) and the body of the vehicle (the sprung portion). One type of suspension system is an independent suspension which typically include an upper control arm, a lower control arm and a hub or knuckle which supports the tire of the vehicle. Each control arm is attached to the frame or other structural component of the vehicle using one or more elastomeric bushings. The elastomeric bushings may consist of an outer metal tube which is pressed into the control arm. A layer of elastomer is positioned within the outer metal housing and an inner metal housing which extends through the center of the layer of elastomer. The inner metal housing is attached to a bracket on the frame. The supporting structure or the sprung portion of the vehicle or a bolt extends through the inner metal and secures the end of the control arm to the frame. As the vehicle travels, relative movement between the sprung and unsprung portions of the vehicle is accommodated by flexing of a coil spring, a torsion bar, an air spring or by another resilient device. The flexing of the resilient device causes the ends of the control arms to pivot on the elastomeric bushings which secure the control arms to the sprung portion of the vehicle.

The elastomeric bushings are used to facilitate this pivotal motion and to isolate the vehicle from shock. The layer of elastomer located between the inner and outer metal housings effectively isolates the sprung portion of the vehicle from the unsprung portion of the vehicle.

Depending on the environment in which the suspension is to act and the particular orientation of the elastomeric bushing on the vehicle, it may be desirable to provide an elastomeric bushing having a relatively high axial spring rate that does not include elastomeric material contacting external bushing components. A high axial rate minimizes relative axial travel between the inner metal housing and the outer metal housing to allow the other suspension components to work more efficiently and reduces overall suspension rate variability. By eliminating any elastomeric material positioned outside of the outer metal housing, a robust design may be provided.

It may be beneficial to provide an elastomeric bushing having a relatively high axial rate using a simplified construction method that presents no special complexity to an end user. The desired performance characteristics are realized by an assembly method that orients two bushing subassemblies in an opposed fashion and utilizes the design characteristics of two individual bushings to employ rubber axial flange features and cupped outer sleeves.

### SUMMARY

This section provides a general summary of the disclosure, and is not a comprehensive disclosure of its full scope or all of its features.

An elastomeric bushing comprises a first bushing subassembly and a second bushing subassembly each in engagement with an outer surface of an inner component. The first bushing subassembly includes a first inner sleeve, a first outer sleeve and a first elastomeric bumper radially positioned between the first inner and first outer sleeves. The first elastomeric bumper includes a first axial flange positioned between a first flange of a first inner sleeve and a first end wall of the first outer sleeve. The second bushing assembly is substantially the same as the first bushing assembly. The first and second inner sleeves of each bushing subassembly are in engagement with the outer surface of the inner component.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is an exploded perspective view of an exemplary elastomeric bushing constructed in accordance with the teachings of the present disclosure;

FIG. 2 is a cross-sectional side view of the elastomeric bushing depicted in FIG. 1;

FIG. 3 is a perspective view of an inner sleeve of a bushing subassembly shown in FIG. 1;

FIG. 4 is a work-in-process fragmentary perspective view of an inner sleeve and elastomeric bumper subassembly; and

FIG. 5 is fragmentary cross-sectional perspective view of one of the elastomeric bushing subassemblies depicted in FIG. 1.

Corresponding reference numerals indicate corresponding parts throughout the several views of the drawings.

### DETAILED DESCRIPTION

An exemplary embodiment elastomeric bushing will now be described more fully with reference to the accompanying drawings with the elastomeric bushing being identified at reference numeral 10.

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

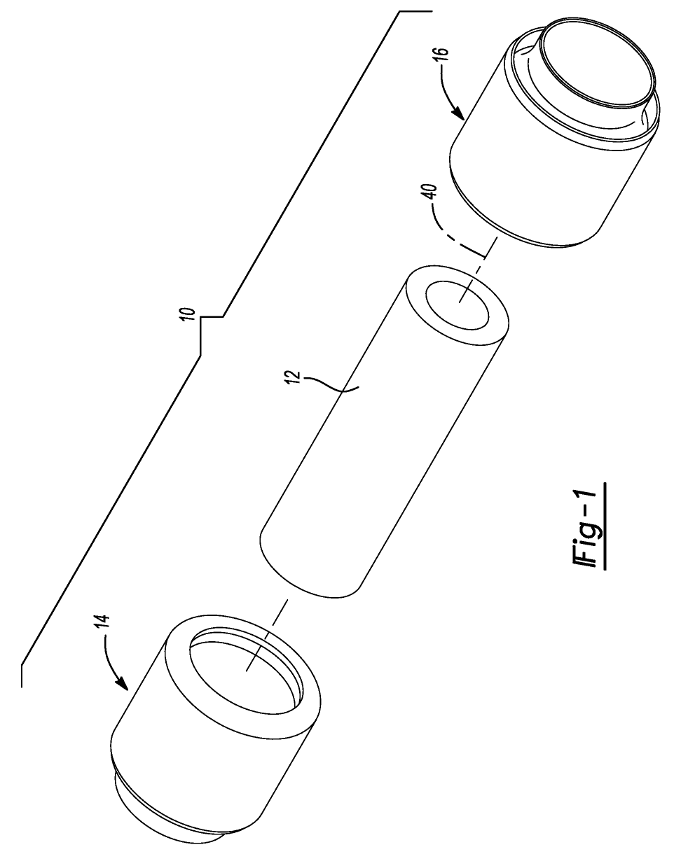

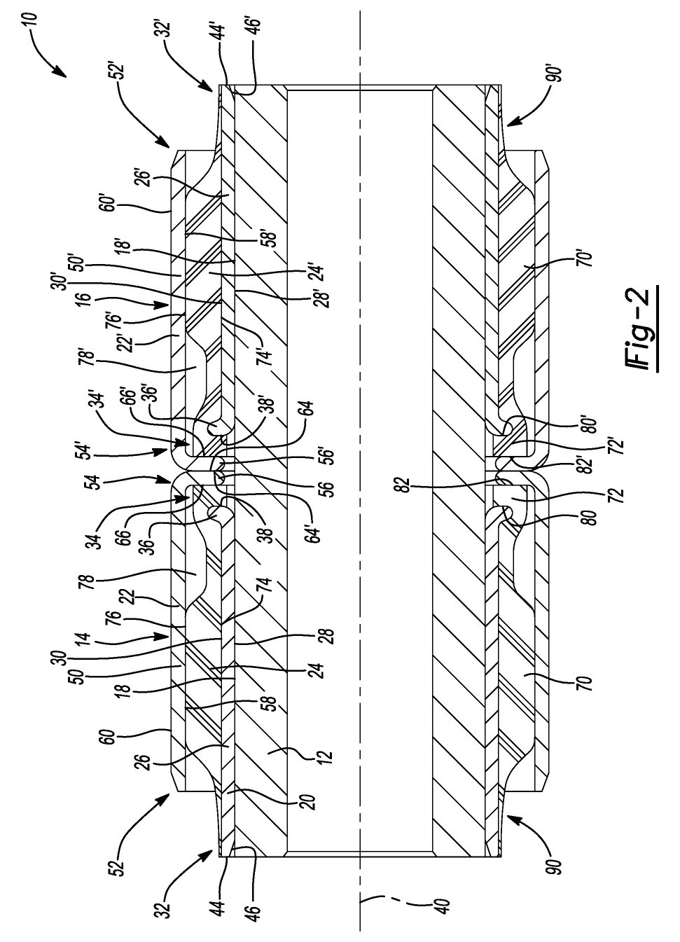

With reference to FIGS. 1-3, elastomeric bushing 10 includes an inner component or inner tube 12, a first bushing subassembly 14, and a second bushing subassembly 16. First bushing subassembly 14 may be substantially similar to or identical to second bushing subassembly 16. As such, only first bushing subassembly 14 will be described in detail. FIG. 1 provides an exploded perspective view of elastomeric bushing 10. FIG. 2 depicts elastomeric bushing 10 in a final assembled condition where each of first bushing subassembly 14 and second bushing subassembly 16 are press fit into engagement with an outer surface 18 of inner tube 12. It should be appreciated that while the inner component depicted is shown as inner tube 12, it is contemplated that the inner component may alternatively be configured as a solid pin or bar without departing form the scope of the present disclosure.

First bushing subassembly 14 includes an inner sleeve 20, an outer sleeve 22, and an elastomeric bumper 24 positioned radially therebetween. Inner sleeve 20 is a hollow cylindrically shaped member including a wall 26 having an inner cylindrical surface 28 and an outer cylindrical surface 30. Inner sleeve 20 includes a first end 32 and an opposite second end 34. A radially outwardly extending flange 36 is integrally formed with wall 26 at second end 34. Flange 36 includes a land 38 extending at an angle to a longitudinal axis 40 of inner sleeve 20. The angle is contemplated to range between forty-five and ninety degrees. Wall 26 includes an end face 44 positioned at first end 32. End face 44 may extend transversely to longitudinal axis 40. A chamfer 46 may be formed at first end 32 to ease installation on inner tube 12.

Outer sleeve 22 is a cup-shaped component including a hollow cylindrical sidewall 50 having a first end 52 and an opposite second end 54. A radially inwardly extending end wall 56 is integrally formed with sidewall 50 and positioned at second end 54. Sidewall 50 includes an inner cylindrical surface 58 and an outer cylindrical surface 60. End wall 56 includes an annular outer surface 64 and an annular inner surface 66.

Elastomeric bumper 24 is a one-piece monolithic component including a cylindrical body portion 70 and an axial flange portion 72. Body portion includes an inner surface 74 bonded to outer surface 30 of inner sleeve 20. Body portion includes a cylindrical outer surface 76 in biased engagement with inner surface 58 of outer sleeve 22. It should be appreciated that body portion 24 need not, but may, fill the entirety of the annular gap between inner surface 58 of outer sleeve 22 and outer surface 30 of inner sleeve 20. In the embodiment depicted in the Figures, an open cavity 78 remains. Provision of cavity 78 allows a designer to tailor the radial response characteristics of elastomeric bushing 10. Axial flange portion 72 includes a first surface 80 bonded to land 38 of inner sleeve 20. An opposite second surface 82 of axial flange portion 72 is positioned in engagement with annular inner surface 66 of outer sleeve 22. In the embodiment depicted in the Figures, flange 36 is entirely encapsulated by elastomeric bumper 24.

As previously noted, second bushing subassembly 16 is substantially similar to first bushing subassembly 14. For clarity, like elements will not be discussed in detail but such elements will be identified in the Figures with similar reference numerals including a prime suffix. The construction of second bushing subassembly 16 is substantially the same as previously described in relation to first bushing subassembly 14.

From a manufacturing standpoint, inner sleeves 20, 20’ may be constructed from a mild steel such SAE 1008-1035. Elastomeric bumpers 24, 24’ may be constructed from a natural rubber or other suitable elastomeric material. Inner tube 12 and outer sleeves 22, 22’ may be formed from a mild steel such as SAE 1008, SAE 1010, or SAE 1020.

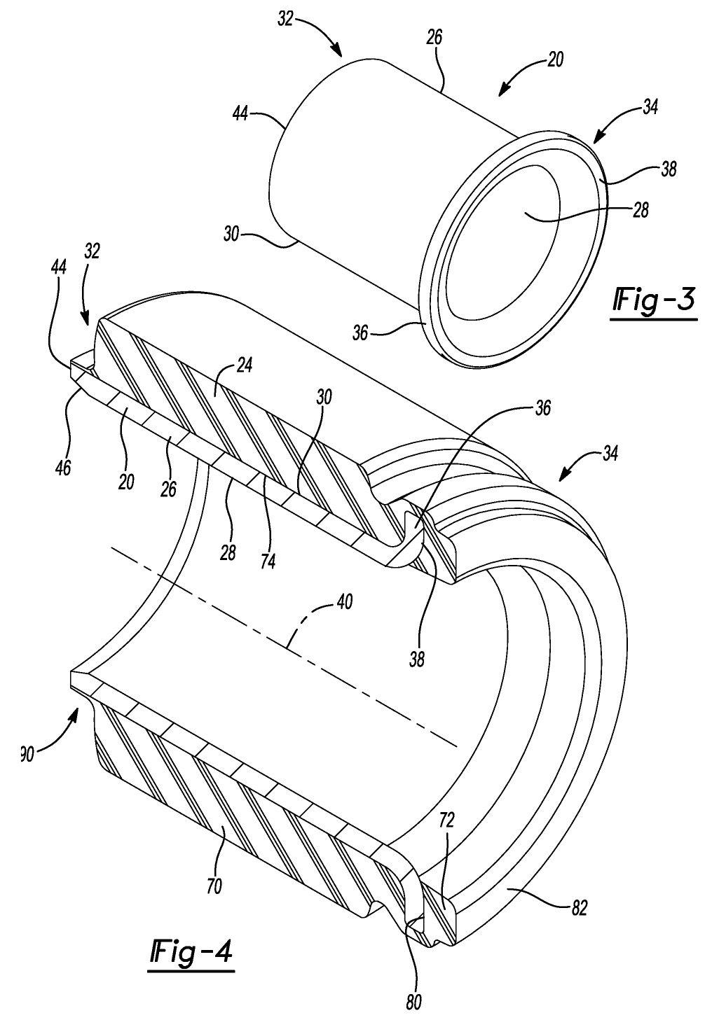

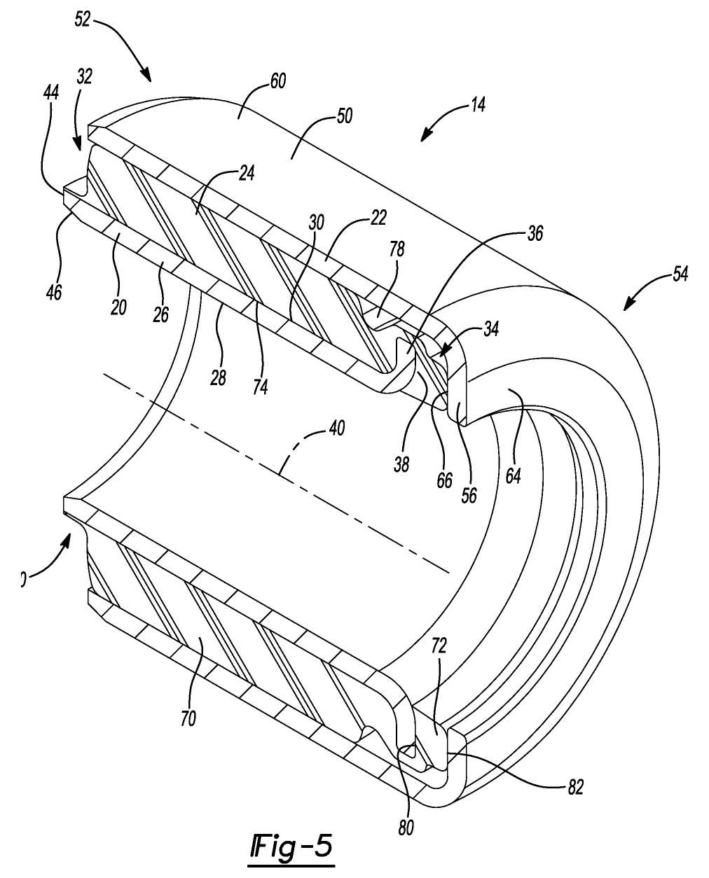

FIGS. 3-5 pictorially represent a method of assembling elastomeric bushing 10. At the beginning of the method, flanged inner sleeve 20 is constructed as shown in FIG. 3. An inner sleeve and elastomeric bumper subassembly 90 is manufactured by injecting a liquid elastomer into a mold containing inner sleeve 20. At the completion of the injection process, elastomeric bumper 24 is bonded to outer surface 30 of inner sleeve 20 as shown in FIG. 4. After molding, body portion 70 exhibits an outer diameter having a size slightly greater than an inner diameter defined by inner surface 58 of outer sleeve 22. At the method step depicted in FIG. 5, inner sleeve and elastomeric bumper subassembly 90 are axially inserted within outer sleeve 22. Elastomeric bushing subassembly 90 is translated toward the cupped second end 54 until second surface 82 of axial flange portion 72 engages annular inner surface 66. At this time, first end 32 of inner sleeve 20 protrudes from outer sleeve 22 and first bushing subassembly 14 is complete. Second bushing subassembly 16 is manufactured in the same manner previously described in relation to first bushing subassembly 14 and the details will not be repeated.

The method of assembling elastomeric bushing 10 continues by obtaining inner tube 12 and concentrically aligning inner sleeve 20, inner sleeve 20’ and inner tube 12 along axis 40 as shown in FIG. 1. The method further includes axially translating first bushing subassembly 14 and second bushing subassembly 16 toward one another. Inner sleeve 20 is engaged in a press-fit interconnection with inner tube 12 and inner sleeve 20’ is also press-fit on inner tube 12. First bushing subassembly 14 and second bushing subassembly 16 continue to be axially translated toward one another on inner tube 12 until annular outer surface 64 of outer sleeve 22 is placed in direct engagement with outer surface 64’ of outer sleeve 22’ as shown in FIG. 2. The first bushing subassembly 14 and second bushing subassembly 16 may be positioned symmetrically in relation to the axial midpoint of inner tube 12. Assembly of the elastomeric bushing 10 is complete.

During operation after installing elastomeric bushing 10 on a vehicle, the opposed orientation of outer sleeve 22 and outer sleeve 22’ in conjunction with the position of axial flange portion 72 and axial flange portion 72’ will be appreciated. The dual elastomeric axial flange feature provides an increased axial load rate. The configuration described and depicted in the figures provides a device for limiting axial travel of inner tube 12 relative to outer sleeves 22, 22’ without an elastomer being positioned externally of outer sleeve 22, 22’. When loaded, axial displacement of inner tube 12 relative to outer sleeves 22, 22’ will compress axial flange portions 72, 72’ thereby providing increased axial rates while limiting relative axial movement between the components.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. Modifications and variations of the present disclosure are possible in light of the above teachings and may be practiced otherwise than as specifically described while within the scope of the appended claims.

What is claimed is:

1. An elastomeric bushing comprising:
an inner component having an outer surface;
a first bushing subassembly including a first inner sleeve, a first outer sleeve and a first elastomeric bumper radially positioned between the first inner sleeve and the first outer sleeve, wherein the first inner sleeve includes a first flange, the first outer sleeve includes a radially extending first end wall and the elastomeric bumper includes a first axial flange positioned between the first flange and the first end wall; and
a second bushing subassembly including a second inner sleeve, a second outer sleeve and a second elastomeric bumper radially positioned between the second inner sleeve and the second outer sleeve, wherein the second inner sleeve includes a second flange, the second outer sleeve includes a radially extending second end wall and the elastomeric bumper includes a second axial flange positioned between the second flange and the second end wall, wherein the first and second inner sleeves are in engagement with the outer surface of the inner component.

2. The elastomeric bushing according to claim 1, wherein the first end wall and the second end wall are positioned adjacent one another.

3. The elastomeric bushing according to claim 1, wherein the first inner sleeve and the second inner sleeve are press fit on the inner component.

4. The elastomeric bushing according to claim 1, wherein the first axial flange of the first elastomeric bumper is axially compressible between the first flange and the first end wall.

5. The elastomeric bushing according to claim 1, wherein the first and second bushing assemblies are identical.

6. The elastomeric bushing according to claim 1, wherein the first elastomeric bumper includes a body portion simultaneously engaging the first outer sleeve and the first inner sleeve.

7. The elastomeric bushing according to claim 1, wherein the first axial flange is spaced apart from a cylindrical sidewall of the first outer sleeve.

8. The elastomeric bushing according to claim 1, wherein the first inner sleeve is a hollow cylindrically-shaped one-piece monolithic component including the first flange.

9. The elastomeric bushing according to claim 1, wherein the first elastomeric bumper is bonded to the first inner sleeve.

10. The elastomeric bushing according to claim 9, wherein the second elastomeric bumper is bonded to the second inner sleeve.

11. The elastomeric bushing according to claim 1, wherein the first inner sleeve is coaxially aligned with the first outer sleeve.

12. The elastomeric bushing according to claim 11, wherein the first inner sleeve is coaxially aligned with the second inner sleeve.

13. The elastomeric bushing according to claim 1, wherein the first inner sleeve axially extends beyond the first outer sleeve.

14. An elastomeric bushing comprising:
an inner component;
a first bushing subassembly circumscribing the inner component and including a first inner sleeve, a first elastomeric bumper disposed around and directly engaging the first inner sleeve, and a first outer sleeve disposed around the first inner sleeve and the first elastomeric bumper, wherein the first inner sleeve includes a radially outwardly extending first flange, the first outer sleeve includes a radially inwardly extending first end wall and the elastomeric bumper includes an axial flange positioned between and in engagement with the first flange and the first end wall; and
a second bushing subassembly circumscribing the inner component and including a second inner sleeve, a second elastomeric bumper disposed around and directly engaging the second inner sleeve, and a second outer sleeve disposed around the second inner sleeve and the second elastomeric bumper, wherein the second inner sleeve includes a radially outwardly extending second flange, the second outer sleeve includes a radially inwardly extending second end wall and the elastomeric bumper includes an axial flange positioned between and in engagement with the second flange and the second end wall, wherein the first and second inner sleeves are in press-fit engagement with the inner component.

15. The elastomeric bushing according to claim 14, wherein the first end wall and the second end wall are positioned adjacent one another.

16. The elastomeric bushing according to claim 14, wherein the first axial flange of the first elastomeric bumper is axially compressible between the first flange and the first end wall.

17. The elastomeric bushing according to claim 14, wherein the first and second bushing assemblies are identical and rotated in opposite directions.

18. The elastomeric bushing according to claim 14, wherein the first elastomeric bumper includes a body portion simultaneously engaging the first outer sleeve and the first inner sleeve.

19. The elastomeric bushing according to claim 18, wherein the first axial flange is spaced apart from a cylindrical sidewall of the first outer sleeve.

20. The elastomeric bushing according to claim 14, wherein the first inner sleeve is coaxially aligned with the second inner sleeve.
